(19) United States
(12) Patent Application Publication
(10) Pub. No.: US 2006/0169151 A1
(43) Pub. Date: Aug. 3, 2006

(54) Bakeware with accessible handles

(76) Inventor: Matthew L. Griffin, Indianapolis, IN (US)

Correspondence Address: MATTHEW L. GRIFFIN, 6337 MAPLE DR, INDIANAPOLIS, IN, 46220, US

(21) Appl. No.: 11/331,299

(22) Filed: Jan. 12, 2006

Related U.S. Application Data
(60) Provisional application No. 60/644,119, filed on Jan. 14, 2005.

(51) Int. Cl. A23P 1/00

(52) U.S. Cl. 99/426

(57) ABSTRACT

A kitchenware baking pan that retains accessibility to its handles 30 after the pan has been inverted to remove a baked good using handles found on opposite sidewalls 20 and located an accessibility distance 40 from the pan upper bakeware rim 10, providing full handle access after the pan has been inverted on a flat surface and is resting on its upper bakeware rim to remove a baked good.

### CROSS-REFERENCE TO RELATED APPLICATIONS

This application is entitled to the benefit of Provisional Patent Application No. 60/644,119 filed 2005 Jan. 14.

### BACKGROUND

1. Field of Invention

This invention relates to kitchenware, specifically to an improved baking pan that allows users to pick up the pan easily after it has been inverted on a flat surface for the purpose of removing the baked good inside.

2. Discussion of Prior Art

When cakes and other baked goods are baked, they are typically removed from the bakeware for the purpose of frosting and/or serving. Removing baked goods from their pan is typically done by flipping/inverting the bakeware on to a flat surface, and then lifting the bakeware up and off of the baked good.

Existing bakeware comes with or without handles. Handles on bakeware are used to pick it up and also to flip it over/invert it to remove the baked good after baking. Existing bakeware and prior art for bakeware has handles located flush with the upper rim of the bakeware. As a result, after the pan is inverted and lying flat on a surface, the handles along with the upper rim are flush with that surface. This eliminates the access to the handles, in that there is no space between the flat surface and the handles. The user can no longer get their fingers under the handles to lift the pan off of the baked good. This typically results in the user gripping the sides of the pan, or attempting to pry their fingers underneath the handles. This makes lifting hot inverted bakeware from a baked good difficult and on occasion dangerous.

### SUMMARY

This invention is a piece of bakeware with handles located lower than the upper bakeware rim, thus allowing the pan to be inverted on a flat surface and still provide space between that flat surface and the handles, thus allowing the handles to be easily accessed for the purpose of gripping and lifting the bakeware up and off of the baked good said article comprising
(a) A baking pan of predetermined material said baking pan having an upper bake ware rim and sidewalls said baking pan having handles protruding from its sidewall(s) said handles located a specified distance away from the upper bakeware rim.
   Whereby allowing the baking pan to be inverted on a flat surface and still provide distance between the flat surface and the handles.

### OBJECTS AND ADVANTAGES

Accordingly, the advantage of my invention is:
(a) My bakeware allows the user to easily access handles once the bakeware has been inverted on a flat surface. By placing the handles a distance away from the upper bakeware rim they remain accessible once the bakeware has been inverted on a flat surface and is resting on its upper bakeware rim. By using this bakeware, the user can increase their control of the bakeware after it has been inverted on a flat surface for baked good removal.

### DRAWING FIGURES

In the drawings, closely related figures have the same number but different alphabetic suffixes.

FIG. 1 shows a plan view of the Bakeware with Accessible Handles.

FIGS. 2A and 2B show elevation views of the Bakeware with Accessible Handles.

FIG. 3 shows an elevation view of the Bakeware with Accessible Handles inverted on a flat surface

### REFERENCE NUMERALS IN DRAWINGS

10 Upper Bakeware Rim
20 Sidewall
30 Handle
40 Accessibility Distance

### DESCRIPTION OF INVENTION

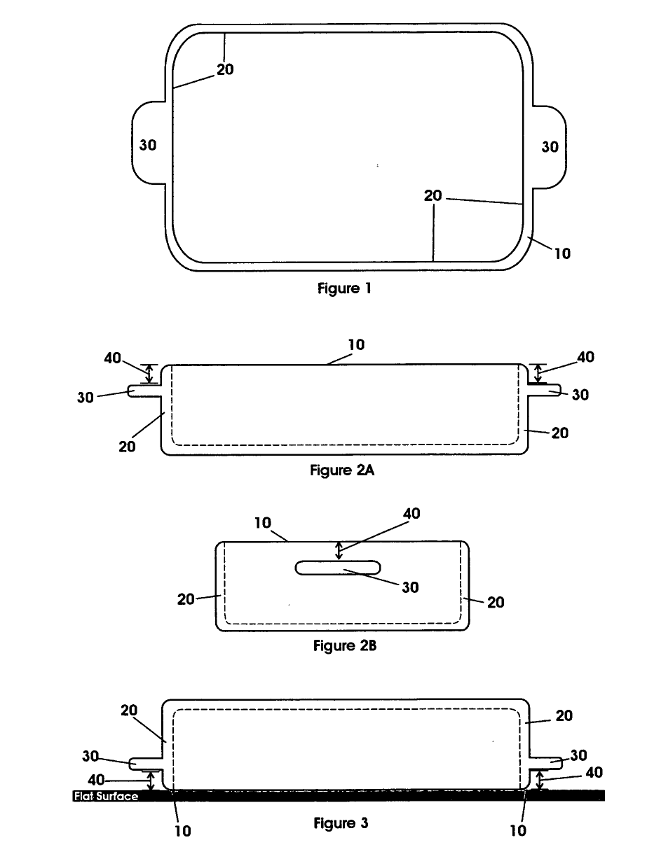

A preferred embodiment of the Bakeware with Accessible Handles is illustrated in FIG. 1 (plan view), FIGS. 2A-2B (elevation views), FIG. 3 (plan view of Bakeware with Accessible Handles inverted on a flat surface). It is a cast aluminum pan with the typical thickness of existing cast aluminum pans used for baking. It measures 13 inches in length, 9 inches in width, and 2 inches in depth. The bakeware has an upper bakeware rim 10 (1) and four sidewalls 20 (1). The bakeware has two handles 30 (1) located on opposite sidewalls. The bakeware has two accessibility distances 40 (2A) each located on a sidewall between a handle and the upper bakeware rim.

Operation of Invention

The Bakeware with Accessible Handles is operated like any other bakeware. After a baked good is baked within said bakeware, the bakeware is inverted on a flat surface to remove the baked good. Once inverted the bakeware rests upon its upper bakeware rim 10. With accessibility distances 40 located on the sidewalls 20 between the handles 30 and the upper bakeware rim 10, the user can access the handles to lift the bakeware up from the flat surface.

Conclusion, Ramifications, and Scope of Invention

Thus the reader will see that the Bakeware with Accessible Handles provides a user access to grip its handles after it has been inverted and is resting on a flat surface, and thus permitting the user to use the handles to lift the bakeware up and off of the flat surface.

While my above description contains many specifications, these should not be construed as limitations on the scope of the invention, but rather as an exemplification of one preferred embodiment thereof. Many other variations are possible.

For example, the bakeware can have:
Different bakeware dimensions such as 8 inches by 8 inches by 1.5 inches etc.;
More than 2 handles such as 3, 4, etc.;
The bake ware can be made of different materials such as glass, ceramic etc.
   Accordingly, the scope of the invention should be determined not by the embodiment(s) illustrated, but by the appended claims and their legal equivalents.

I claim:

1. A kitchenware baking pan that retains full accessibility to its handles when the pan is inverted on a flat surface said article comprising a one piece baking pan having sidewalls and a baking cavity enclosed by said sidewalls, the top edge of said sidewalls forming an upper bakeware rim along the top of the baking cavity, said sidewalls having handles on their exteriors outside of the baking cavity, said handles being located on opposite sidewalls, said handles located a vertical distance from the upper bakeware rim whereby allowing full access to the handles when the baking pan is inverted on a flat surface.
